(19) United States
(12) Patent Application Publication
(10) Pub. No.: US 2015/0368039 A1
(43) Pub. Date: Dec. 24, 2015

(54) Framed Transport And Distribution Container For Bulk Granular Product And Method

(71) Applicants: Brian Lee Cochrum, Senoia, GA (US); Drew Jason Lofstad, Fayetteville, GA (US)

(72) Inventors: Brian Lee Cochrum, Senoia, GA (US); Drew Jason Lofstad, Fayetteville, GA (US)

(21) Appl. No.: 14/646,896

(22) PCT Filed: Mar. 22, 2014
(86) PCT No.: PCT/US14/31525

§ 371 Date: May 22, 2015

Related U.S. Application Data
(60) Provisional application No. 61/804,502, filed on Mar. 22, 2013.

(51) Int. Cl. B65D 88/54; B65G 37/00; G01S 19/24; B65D 88/32; B65D 88/66; B65G 53/16; B65G 53/36

(52) U.S. Cl. CPC B65D 88/548; B65G 53/16; B65G 37/00; B65G 53/36; B65D 88/32; B65D 88/66; G01S 19/24

(57) ABSTRACT

A transport and distribution apparatus for bulk granular product in a container mounted to an ISO frame, the container having opposing side walls and opposing end walls closed by a cover that has hatch openings for providing entry of a bulk granular product into the container, with a plurality of chutes opposing the cover and each having a discharge port that connects through a valve to a product discharge conduit. An air supply provides an air flow through the product discharge conduit to discharge the bulk product from the apparatus and an air plenum disposed within the container proximate the cover communicates pressurized air into the container.

### RELATED APPLICATION

The present application claims the benefit of prior provisional patent application Ser. No. 61/804,502 filed 22 Mar. 2013 with the United States Patent And Trademark Office, and is incorporated herein by reference in its entirety.

### TECHNICAL FIELD

The present invention relates to apparatus and methods for transporting and distributing bulk granular products. More particularly, the present invention relates to portable framed containers for storage and intermodal transportation of bulk granular products or aggregate material for selective distribution by gravity-fed, discharge flow from the container facilitated by pneumatic assistance.

### BACKGROUND OF THE INVENTION

Bulk materials such as aggregate, fluidal materials, granular products and the like are a significant component of manufacturing and processing in industrial applications. These materials often must be moved long distances and in large quantities and volumes from supplier to end user. Many different types of apparatus have been developed for the storage, transportation and distribution of bulk materials. With recent increasing developments in the petrochemical exploration and extraction industry, the need for bulk granular materials has likewise increased, and particularly, the need for storage, transportation and distribution of hydraulic fracturing sand.

There are currently at least four types of apparatus for transporting bulk aggregate being utilized by the oil and natural gas sectors for supplying hydraulic fracturing (“frac”) sand from suppliers to often remote drill sites accessible by travel on narrow roads. These types are referred to as flexible intermediate bulk containers (FIBCs) or as characterized in the trade “super sacks”, pneumatic tanker trucks, railroad hopper cars, and river barges. The super sacks apparatus are large fabric bags. These are costly and cumbersome. The bags require significant manpower on site to unload, and the process is time consuming and leads to frustration during the unloading activities. There are also the problems presented by having to store and dispose of empty bags. While pneumatic trucks provide portable delivery of larger quantities of bulk materials over the super sacks, and thus leads to more efficient unloading of frac sand at a well site, there are drawbacks. Due to limited space on-site, a backlog of trucks delivering various materials may lead to congested roads in the area of the drill site. An on-site bottleneck may develop because of only being able to offload the trucks when the frac tanks are emptied. Also, this transportation mode frequently becomes costly through the demurrage charges incurred. Hopper cars are quite efficient for hauling bulk materials via train and rail systems across long distances; however, they are frequently not able to deliver product directly to the well site, and therefore prove costly through multiple handling and equipment charges necessary to transload the frac sand into other vehicles for site delivery. Additionally, usage demands have led to a lag in the ready supply of hopper cars available on the market and production of hopper cars is costly and backlogged. River barges are perhaps the most cost effective method for long distance transport. However, with a majority of high quality sand originating in the Wisconsin/Minnesota area, issues arise with the river being closed to barge traffic shutting down for periods due to weather. Additionally, the barge transport incurs the similar costly handling and supplemental equipment costs and charges that are associated with the hopper cars. Each of these transportation apparatus and associated transportation and delivery methods, while providing for transportation and delivery of bulk granular product, nevertheless experience drawbacks that hinder the supply of frac sand to mining companies.

These transportation and delivery apparatus and methods further have limitations on tracking of inventory, for location and delivery and fail to monitor, evaluate and report on various handling and storage factors that may affect the quality of the bulk material upon delivery. Also, multiple handling of bulk materials during the mere transportation phases of the supply and delivery chain for such products provides opportunities for product degradation and contamination

Accordingly, there is a need for improved portable intermodal storage, transportation, and distribution of bulk granular products. It is to such that the present invention is directed.

### SUMMARY OF THE INVENTION

The present invention meet the needs in the art by providing a transport and distribution apparatus for bulk granular product, comprising a frame and a container mounted to the frame. The container comprises a pair of opposing side walls and a pair of opposing end walls. A cover attaches to the side walls and end walls to close an upper end of the container. The cover defines a plurality of openings each selectively closed by a hatch plate, for providing entry of a bulk granular product into the container. An air plenum is disposed within the container proximate the cover. A plurality of chutes attach to the lower side walls opposing the cover and each has a discharge port. A product discharge conduit connects at a first end to a supply of pressurized air and connects to a plurality of connector pipes that each connect to a respective one of the discharge ports through a respective valve that selectively positions (1) open for a portion of the bulk granular product to flow from the container through the discharge port into the product discharge conduit or (2) closed for restricting outflow of bulk material product from the container. An air supply pipe connects at a first end to the supply of pressurized air and at an opposing end to the air plenum, for communicating pressurized air into the container.

In another aspect, the present invention provides a method of distributing bulk granular product from a container, comprising the steps of:
(a) providing a bulk granular product to a container held within a frame of a transportation apparatus, the container comprising:
   a pair of opposing side walls and a pair of opposing end walls,
   a cover attached to the side walls and end walls to close an upper end of the container, the cover defining a plurality of openings each selectively closed by a hatch plate, for providing entry of a bulk granular product into the container,
   an air plenum open to the container;
   a plurality of chute assemblies attached to the side walls opposing the cover and having a discharge port; and
   a plurality of valves, each connected with a connector pipe to a respective one of the discharge ports and to a product discharge conduit;
(b) selectively moving the plurality of valves from a closed position to prevent outflow of the bulk granular product to an open position to permit flow of the bulk granular product from the container;
(c) providing pressurized air to the product discharge conduit upstream of a first one of the plurality of valves; and
(d) providing pressurized air into the container through an air supply pipe connected to the plenum.

In yet another aspect, the present invention provides a networked system for tracking of storage and transport apparatus for bulk granular products for a plurality of users of said apparatus, comprising a remote computer server that maintains a database having a plurality of records of container data with each record comprising a container identifier, a date, a location, a temperature value and a humidity value. A data receiver associated with the computer server provides for receiving container data communicated through a communications network. The network includes a plurality of transport and distribution apparatus for bulk granular products. Each apparatus comprises a frame holding a container for storing and transporting bulk materials, and includes an electronic complex attached to the apparatus and communicating with a location determining device, a temperature sensor and a humidity sensor, each of said sensors communicating respective signals representative of a temperature and a humidity within a materials holding cavity defined by the container, and the location determining device attached to the container. The apparatus further comprises a controller configured for periodically interrogating the location determining device, the temperature sensor and the humidity sensor and receiving signals therefrom reflecting the location of the container and its temperature and humidity, and a communicator for communicating to the data receiver the container data comprising the location, temperature, and humidity signals determined upon interrogation by the controller together with a unique identifier associated with the container. An analyzer is configured for receiving an inquiry from at least one of a plurality of users of the storage and transport apparatus as to container information and responding thereto with reports after interrogating the database,

whereby a central coordinator being provided for tracking the location, date, temperature and humidity for the plurality of transport and distribution apparatus reports to apparatus users with container data in response to the inquiry.

Objects, advantages, and features of the present invention will be readily apparent upon a reading of the following detailed description in conjunction with the drawings and the appended claims.

### BRIEF DESCRIPTION OF THE DRAWINGS

FIG. 1 illustrates in side view a first embodiment of a framed portable storage and intermodal transportation container for bulk granular products according to the present invention.

FIG. 2 illustrates in end view the framed portable storage and intermodal transportation container illustrated in FIG. 1.

FIG. 3 illustrates in side view a second embodiment of a framed portable storage and intermodal transportation container for bulk granular products according to the present invention.

FIG. 4 illustrates in end view the framed portable storage and intermodal transportation container illustrated in FIG. 3.

FIG. 5 illustrates in side view a hatch for closing the openings in the cover of the framed portable storage and intermodal transportation container illustrated in FIG. 3.

FIG. 6 illustrates a smooth interior edge between adjacent walls of the storage container.

FIG. 7 illustrates in perspective view the framed portable storage and intermodal transportation container illustrated in FIG. 3.

FIG. 8 illustrates in side view the framed portable storage and intermodal transportation container illustrated in FIG. 3 attached to a trailer of truck for transportation to a site for distribution of bulk granular product from the container.

FIG. 9 is a schematic illustration of a networked system for tracking of storage and transport apparatus for bulk materials for a plurality of users of said apparatus, in accordance with the present invention.

### DETAILED DESCRIPTION

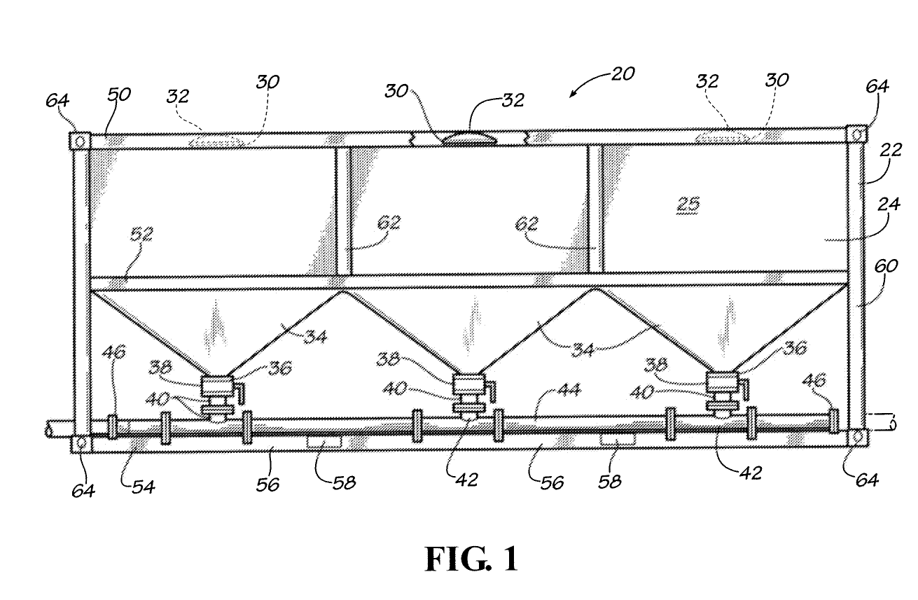

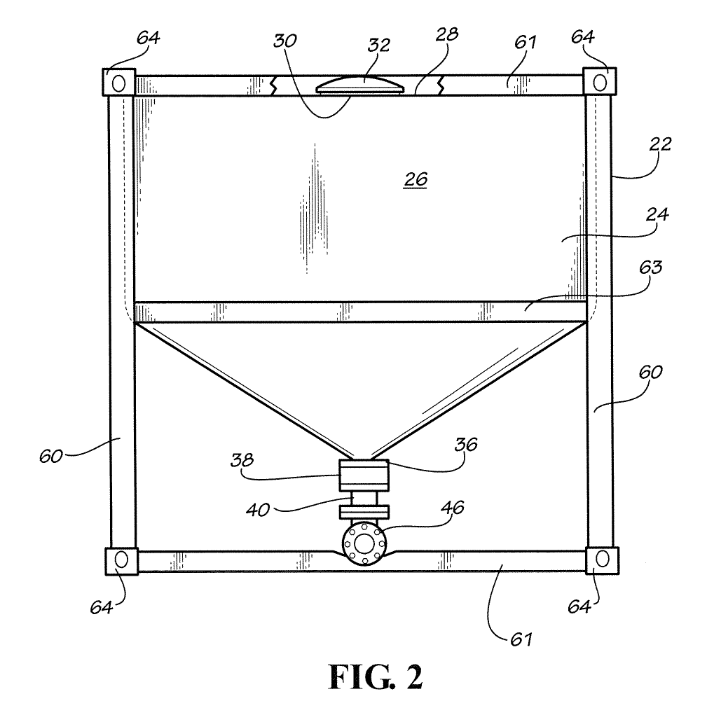

With reference to the drawings, in which like parts have like identifiers, the present invention provides a portable storage and transportation apparatus 20 that receives, stores and transports bulk granular products. As illustrated in side view in FIG. 1 and in end view in FIG. 2, the apparatus 20 includes an ISO frame 22 that holds a storage container 24. The storage container 24 includes opposing side walls 25 and opposing end walls 26. A cover 28 closes an upper end of the storage container 24. The cover 28 defies at least one opening 30 that is selectively closed by a hatch 32. The illustrated embodiment includes three hatches 32 providing spaced-apart inlet ports for communicating bulk granular products into the storage container 24. At least one chute 34 attaches to the bottom of the container 24. The illustrated embodiment includes three chutes 34. Each chute 34 defines a discharge port 36. A valve 38 attaches to the discharge port 36. The valve 38 connects to a connector pipe 40 that connects to a tee 42 extending from a product discharge conduit 44. The product discharge conduit 44 runs longitudinally centrally between the opposing sides 25 of the container. The product discharge conduit 44 includes a coupler 46 at opposing ends. The couplers 46 selectively detachably connect to a supply of pressurized air and to a discharge pipe for moving the bulk granular material to a selection area on a site, such as a drill site, storage site, supply site, and the like, during operation of the apparatus 20. The side walls 25, end walls 26, cover 28, and chutes 34 connect together and to the frame 22 by welding.

The frame 22 includes opposing upper tubes 50, intermediate support tubes 52, and roll-off rails 54. The roll-off rails 54 in the illustrated embodiment assemble from a plurality of elongated tubes 56 that connect to transverse tubes 58. The transverse tubes 58 provide entry for the forks of a forklift vehicle, for lifting and moving the storage container 24. As shown in FIG. 2, a pair of opposing vertical tubes 60 and opposing upper and lower transverse tubes 61 with an intermediate tube 63 form each opposing end of the frame 22. The tubes 60 connect at opposing ends to the upper tubes 50 and roll-off rails 54 as well as to the respective ends of the intermediate support tubes 52. A plurality of opposing intermediate vertical tubes 62 connect at opposing ends to the intermediate support tubes 52 and the upper tubes 50. The distal ends of the upper tubes 50 and the vertical tubes 60 connect in a corner casting 64, or ISO block, for conventional connection of adjacent storage and transportation apparatus 20. Similarly, the distal ends of the roll-off rails 54 and the vertical tubes 60 likewise connect in corner castings 64.

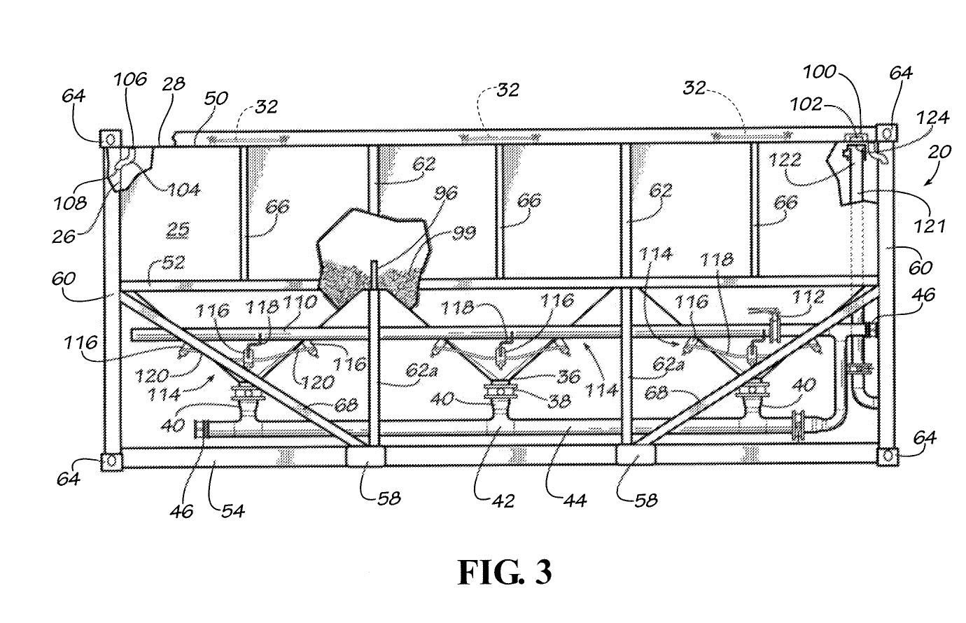

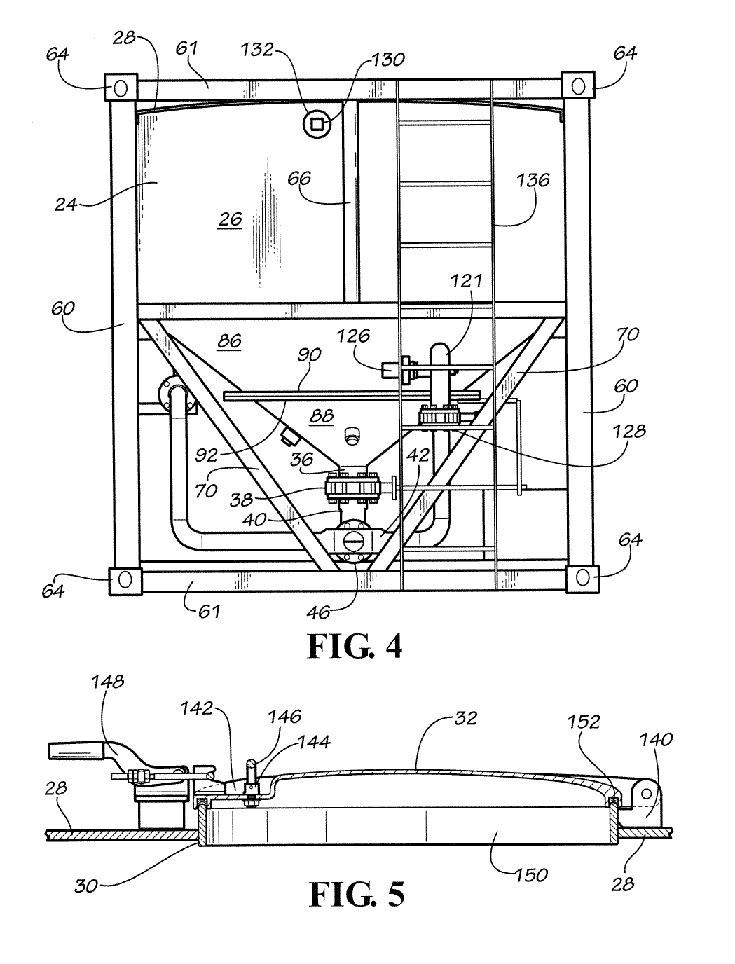

FIG. 3 illustrates in side view, and FIG. 4 illustrates in end view, a second embodiment of a framed portable storage and intermodal transportation container 20 for bulk granular products according to the present invention. This embodiment further includes additional intermediate vertical tubes 62a connected at opposing distal ends to the roll-off rails 54 and the intermediate support tubes 52. An alternate embodiment uses unitary continuous tubes rather than separate tubes 62 and 62a. A plurality of side struts 66 connects between the intermediate support tubes 52 and the upper tube 50. The side struts 66 provide lateral support to the side walls 25 and end walls 26 of the storage container 24. Opposing tubes 68 mount on a diagonal between the respective end tube 60 and the transverse forklift tubes 58 to provide rigidity and strength for the frame 22. Opposing tubes 70 mount on a diagonal between the intermediate tube 63 and the lower transverse tube 61.

As may be appreciated, the cover 28 attaches to an upper edge of the side wall 25 and end wall 26 below an outer upward extent of the tube 50. The hatches 32 in a closed position also sit below the outer upward extent of the tube 50. This structure enables the apparatus 20 to be stacked without components extending beyond the envelope defined by the frame 22. Stacking is accomplished by lifting one apparatus 20 and setting on top of another with alignment of the upper tubes 50, 61 with the opposing roll-off rails 54 and lower transverse tube 62. The two apparatus 20 interconnect with conventional ISO connectors that join the adjacent corner blocks 64.

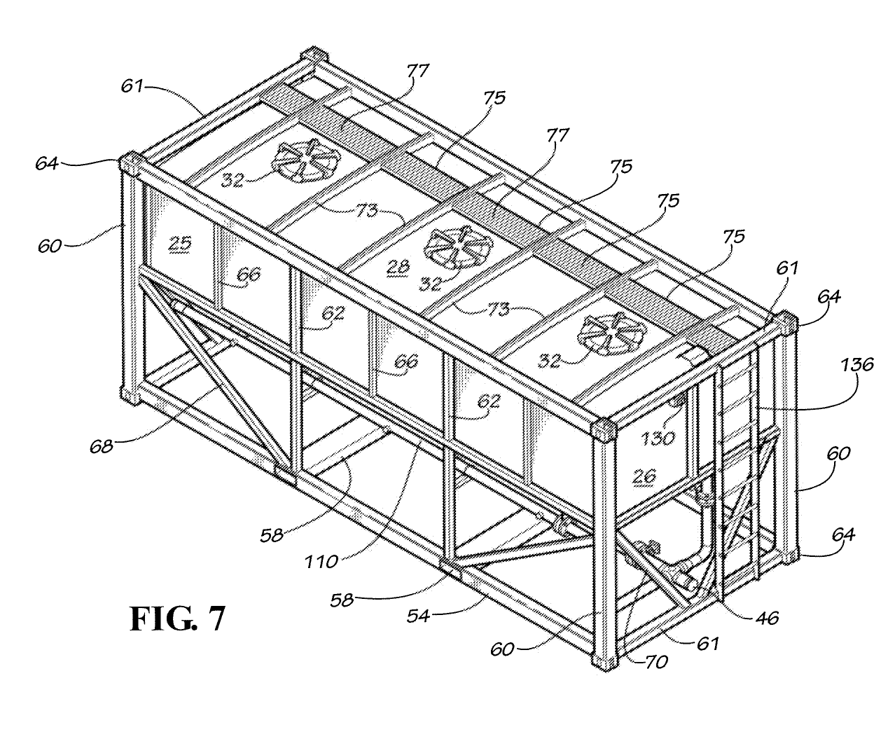

FIG. 7 illustrates in perspective view the framed portable storage and intermodal transportation container 20 illustrated in FIGS. 3 and 4. The illustrated embodiment includes a plurality of transverse struts 73 extending between the opposing upper tube 50 of the frame 22. The cover 28 also includes a walkway 75. The walkway 75 in the illustrated embodiment is a metal grate having spaced apart tread members 77. The tread members may include raised projections for assisting with personnel standing or walking across the cover, such as from a ladder 136 to access and use the hatches 32 during loading of the storage container 24 with bulk granular product.

The chute 34 in the first embodiment shown in FIGS. 1 and 2 assembles from plates 80 oriented at an oblique angle to horizontal for a sloped surface and to define a triangular shape for the chute in side view. The plates taper narrowingly from a first end 82 to an opposing end 84. The first end 82 of the chute attaches to the side walls 25 (or end wall 26) to define an inverted pyramid. The slope facilitates flow of the granular product held within the container 24 to the discharge port 36 defined in the end 84.

As best illustrated in FIG. 4, the chute 34 in the second embodiment that assembles from a hopper 86 and a discharge piping member 88. The hopper 86 includes the walls 80 that attach to the side walls 25 (or end wall 26). An opposing end of the hopper 86 includes a lateral flange 90 that defines a plurality of openings. The discharge piping member 88 similarly has walls oriented at an oblique angle to horizontal to define a sloped surface. A first end of the discharge piping member 88 includes a lateral flange 92 that defines a plurality of openings. The openings in the opposing flanges 90, 92 align, and receive fasteners (not illustrated) to connect the hopper 86 and the discharge piping member 88. A gasket seats between the opposing flanges 90, 92 to seal the connection between the hopper and the discharge piping member. It is to be appreciated that the separable hopper 86 and discharge piping member 88 facilitates access into the storage container 24, for cleaning or servicing that may be required from time-to-time.

FIG. 3 also illustrates in cut-away view a baffle 96 extending upwardly within the storage container 24 to define separate receptacle areas for the bulk granular product 99. It is to be appreciated that separate compartments may be formed by providing a baffle or wall that extends fully from the upper edge of the hopper to the cover 28. Such embodiment would find application for storing and transporting different types of bulk products.

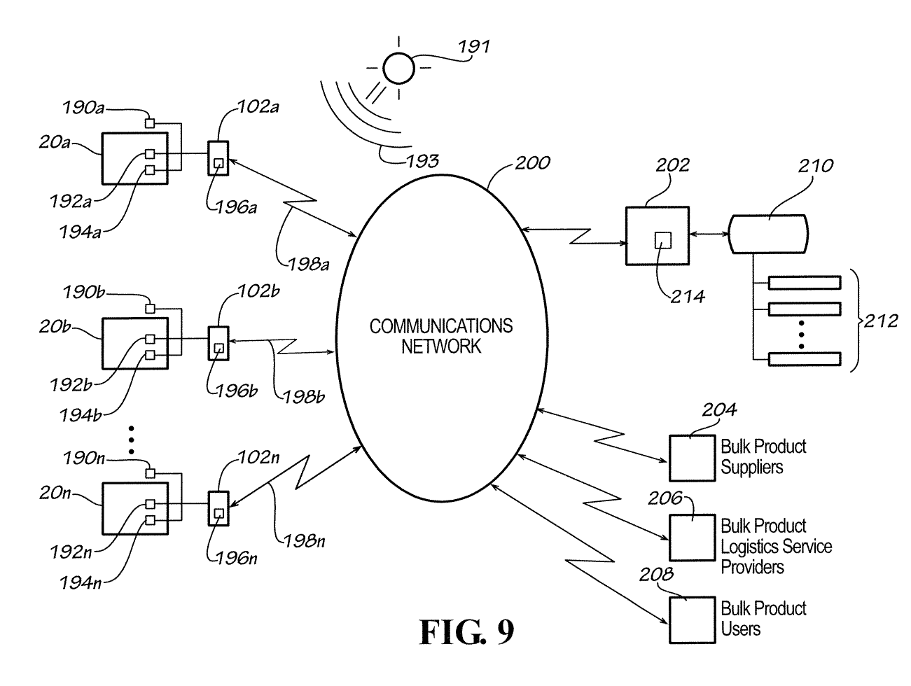

In the illustrated embodiment, a housing 100 mounts to an exterior of the cover 28. With continuing reference to FIGS. 3 and 9, the housing 100 encloses an electronic controller 102 such as a microprocessor device. The controller 102 is configured for communicating with a global positioning device 190, a temperature sensor 192, and a humidity sensor 194. A power supply is provided for operating the controller 102, such as a battery, a solar grid for converting light into energy, and/or a connector for connecting to a supply of electrical current. The temperature sensor 192 and the humidity sensor 194 are positioned within the storage container 24, and connect, for example, with wires to the controller 102. The controller 102 includes a communications device 196, such as a wireless communications device, such as a SIM card or network access device. The controller 102 includes a memory device. The memory device holds data regarding the position of the apparatus 20 and the temperature and humidity of the interior of the container. The controller 102 is configured to monitor periodically the time and the location of the apparatus 20 as determined by the global positioning device 190 that analyzes satellite 191 positioning signals 193, to interrogate the sensors 192 and 194, and to record in memory the date including time, the location, and the temperature and humidity. Periodically, the controller 102 communicates 198 through a communications network 200, the container data and a unique apparatus identifier associated with the particular apparatus 20 to a central computer server 202 that engages in tracking and monitoring of a plurality of the apparatus 20. Alternatively, the controller 102 communicates the container data rather than storing the data for subsequent transfer.

The central server 202 is configured for receiving through the communications network 200 the container data from the container 20 and for communicating with suppliers 204 of bulk granular product, with logistics coordination services 206 such as freight handlers, transportation (trucks, trains, barges), warehousing services, and with 208 customers for bulk material products, for coordinating supply, status, use and return of the plurality of the apparatus 20. The central server 202 includes a database 210 configured for recording a plurality of data records 212 associated with each of the apparatus 20. Each database record comprises at least the container identifier, the date including time, the location, the temperature value and the humidity value, as communicated by the apparatus 20. The central server 202 is configured with an analyzer 214 that receives inquiries, such as from bulk product users of the apparatus 20, as to apparatus status and interrogates the database 210. Reports of container status (location, temperature, humidity) may be provided in response to the inquiries, such as to customer users, logistic providers, or product suppliers, directly or by network communication therebetween.

With continuing reference to FIG. 3, a drain pipe 104 has an inlet 106 open on the cover 28 and connects to an outlet 108 on the end wall 26, for draining water off of the cover 28.

An air supply conduit 110 extends substantially the length of the apparatus 20. The air supply conduit 110 connects at a first end to a supply of pressurized air. The product discharge conduit 44 connects to the air supply conduit 110. A valve 112 controls flow of air from the supply through the conduit 110. Each chute 34 may include a fluffer apparatus generally 114. The fluffer apparatus 114 comprises at least one aerator 116 that attaches to an opening in the wall of the chute. The aerator 116 connects with a supply line 118 to the air supply conduit 110. The aerator 116 provides one-way communication of air into the storage container 24 proximate the chute 34. In the illustrated embodiment, three aerators 116 are provided for each chute 34 with interconnected supply lines 120. The aerators 116 may be removed and the opening in the chute 34 closed with a plug, such as a blind bolt.

In an alternate embodiment, a shaker attaches to an outside wall of the chute 34. The shaker, when operated, causes the chute 34 to vibrate, and thereby fluff the bulk granular product, and thereby assist flow of the bulk granular material through the chute and the discharge port 36 into the product discharge conduit 44, as discussed below.

As best illustrated in FIG. 3, the cover 28 is bowed to have an apex medial the opposing sides 25. The arcuate cover 25 facilitates the storage container 24 accommodating increased internal pressure when operated for dispensing the contents, as discussed below. An air supply pipe 121 extends from an end of the apparatus 22 into the storage container 24. The air supply pipe 121 terminates inwardly of the storage container 24 with a tee 122 having an open port and an end closed by a cap 124. The open port of the tee 122 communicates air into the storage container 24 during operation of the apparatus 20. As illustrated in FIG. 4, a gauge 126 displays the air pressure and a valve 128 may be operated for controlling the pressure of the air in the storage container 24 during operation of the apparatus 20.

With continuing reference to FIG. 4, the apparatus 20 further includes a removable plug 130 selectively positioned in an opening 132 in an upper portion of the side wall 26. The opening 132 may selectively connected to or receive an end of a supply hose for providing blown-in granular material or aggregate carried from a supply by a pressurized air flow. A ladder 136 provides access to the cover 28 and the hatches 32.

FIG. 5 illustrates in detailed cross-sectional view the hatch 32 pivotably connected to a pivot block 140 that attaches to the cover 28. The hatch 32 includes a recess 142 with a mounting bracket 144 to which a handle 146 pivotably attaches. The handle 146 pivots upwardly for lifting the hatch 32 open. The handle 146 pivots downwardly into the recess 142 when the hatch 32 is closed. A conventional toggle clamp 148 attaches to the cover 28 and operates to lock the hatch 32 closed or to release the hatch for opening. The hatch 32 closes the opening 30 in the cover 28. A cylindrical ring 150 extends from the opening 30. The hatch 32 includes a gasket 152 that seats on an upper edge of the ring 150 to seal the opening 30 when the hatch is closed.

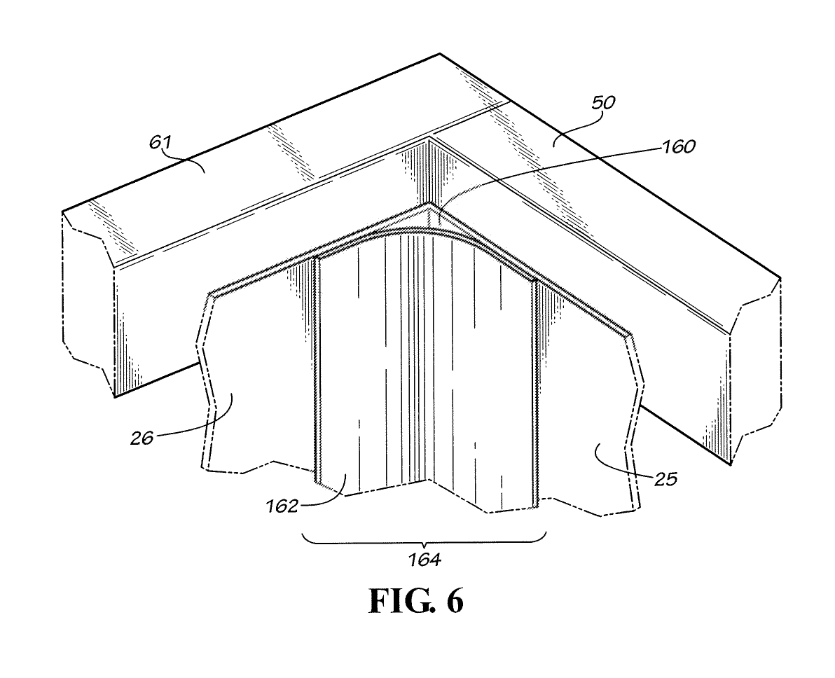

FIG. 6 illustrates in detailed perspective view of an upper portion of the storage container 24 with the end wall 26 and side wall 25 attached together to form corner 160. The end wall 26 welds to the upper transverse tube 61; the side wall 25 welds to the upper tube 50; the end wall 26 welds to the side wall 25. The corner 160 may collect residual product received in the storage container. To prevent this packing of such, the present invention provides smooth transition corners for adjacent plates that form the storage container and the chute. This is accomplished with a plate 162 that is transversely bowed to define an arcuate corner 164. The plate 162 is shown in partial cut-away to illustrate the corner 160 lateral of the plate. Opposing edges 166, 168 of the plate 162 may be smoothed to the interior surface of the wall 25, 26, such as with a weld bead or beveled edge, to resist packing or accumulation of residual product. The plate 162 further aids in material flow from the container when the apparatus 20 operates to discharge the bulk material.

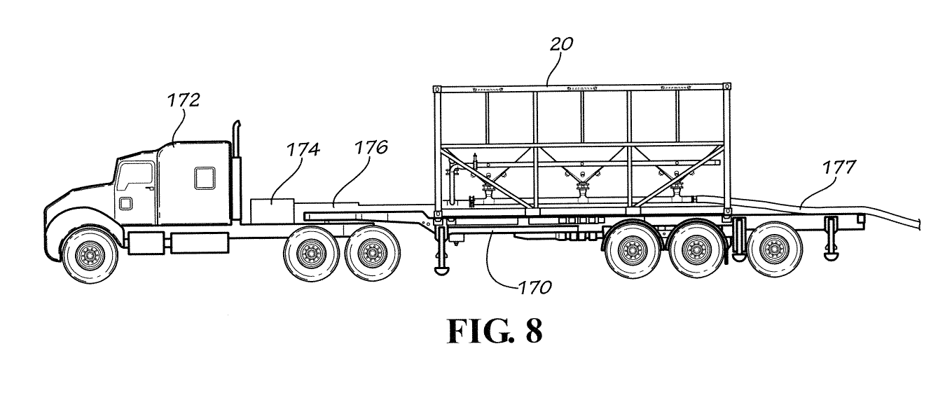

FIG. 8 illustrates in side view the framed portable storage and intermodal transportation container 20 illustrated in FIGS. 3, 4 and 7 attached to a trailer 170 of truck 172 for transportation to a site for distribution of bulk granular product from the container. The container 20 attaches to the trailer 170 using conventional connectors that engage the ISO corner casting blocks 64, as well as other securing devices (tie down straps, cables, and fasteners conventional for such purposes). The truck 172 includes a PTO and blower 174 for providing pressurized air to the apparatus 20 on-site during delivery of bulk granular product. The blower 174 communicates pressurized air through hoses 176 attached between the blower and the connector 46, during operation of the apparatus 20 for discharging bulk granular product 99 from the container at a site. Also illustrated is a discharge hose 177 for communicating the bulk material to a selected location, storage container, or mixing apparatus on the site.

The present invention accordingly provides the container 24 within the ISO frame 22 for the transport or storage of the bulk aggregate product 99. The container 24 preferably defines a generally rectangular box shape with the discharge hopper or chute 34 (and alternatively, piping member being triangular in shape) and a discharge port. In the illustrated embodiment the discharge port 26 is a four-inch diameter exit from the box for connecting to the valve 38. The discharge port 26 may be of a different size depending on the density of the material. The container 24 is pressurizable. To that end, the container 24 may be provided with a blower means, for example the PTO blower attached on a pneumatic truck, trailer tractor rig, or a stationary blower. The blower provides pressurized air to the apparatus 20 to blow the aggregate bulk product from the container 20 to an exterior receiving site. The container 24 is readily loaded from the top through the hatch openings 30. The opening 30 in the illustrated embodiment is twenty-inches, but this too may differ depending on requirements.

The process of unloading the material via gravity and pressure is as follows: The container 24 can hold increased air pressure, for example, as much as 15PSI, but is not limited to that depending upon the density of material. The blower 174 connects with air supply tubes 176 to the connector 46. Operation of the blower provides air into the product discharge conduit 44, the air supply line 110, and the interior air line 121. The gauge 126 may be monitored for internal pressure and controlled by the valve 128. The valve 40 of one of the hoppers 34 is opened. Material drops from storage container 24 sliding on the interior surface of the hopper 34 and the plates 162 through the discharge port 36 and the connector pipe 40 into the product discharge conduit 44. The blowing air in the product discharge conduit 44 facilitates moving of the bulk material through the conduit 44 and outwardly through a conduit outlet. A flex hose may connect to the outlet for communicating the bulk material to a selected location at the site. To insure flow-ability, the storage compartment 24 is pressurized. The air communicates through the supply line 121 into the storage compartment 24. The fluffers, such as the aerators 116 or detachable shakers, assist with flow of the bulk materials. The hopper vibrates, to induce the material to unpack and to flow.

The simple rectangular shape of the storage container 24 and triangular shape (side view) of the hoppers 34 for the apparatus 20 in accordance with the present invention provides a relatively low cost system compared with known systems, including containers of relatively complex shapes. Furthermore such a simple shaped box may experience less fatigue caused by repeated applications of pressure within the container. The box or rectangular shape of the storage container 24 allows for greater storage volume than cylindrical units for same sized frame apparatus such as ISO standard structures having 8 foot wide by 8 foot high×20 foot long frames. The apparatus 20 with the storage container 24 may be readily transported by various means of transportation that carry ISO frame structures, such as trailer, rail car, barge, or freighter. This intermodal container works within existing domestic and global infrastructures. Further, the ISO frame 22 provides for stacking of a plurality of the apparatus 20, to provide supply of bulk materials to site while reducing the storage footprint.

The triangular exits or hoppers 34 connected below the storage container 24 to the product discharge conduit (or evacuation tube) are preferably centered underneath the storage compartment 24 and along a longitudinal axis medial between the ISO frame corner posts 60.

The loading hatch 32 sits below the top of the ISO frame 22 to allow the containers to be stacked. The hatches 32 are weatherproof with an airtight seal to insure no loss of pressure or exposure to elements. The hatches 34 connected to the storage compartment that is made from suitable materials to hold expected pressures, for example up to at least 15 PSI. The specification of material may be determined upon various factors including the density of the bulk material that for storage and transport in the container 24. Further the individual storage compartments within the container 24 are connected to the triangular apex discharge that are sloped sufficiently for flow of the bulk material.

As noted above, the triangular hoppers 34 connect through the respective valve 40 that is manually operated to release the bulk material into the product discharge tube 44. In alternate embodiment, a controller remotely operates the valves 40. The product discharge tube 44 filled with air pressure allows the bulk material to fall under gravity from the storage compartment 24 and the flowing pressurized air moves the bulk materials along the conduit and outwardly for deposit at desired location, dependent upon the end users demands. Connected to the storage container 24 may be a pressure release valve with gauges that give the ability to the end user to monitor the pressure in the container 24 and control air inflow so that the container does not reach pressures higher than design.

It is to be appreciated that the structure of the apparatus 20 permits linking multiple containers 24, such as using a flexible tube, for example located at the top of the storage compartment. Due to the fact that these containers can be networked together allows for simplified storage and transport of large quantities of material. The assembly of valves and tubes are easily replaced if damaged. The stackability of the containers provides on-site storage of bulk materials as needed in a reasonable footprint.

As noted above, the interior walls of the storage container 24 when joined provide a continuous reception surface without exposed corner joints. The internal surfaces can, for instance, be sanded and coated for both smooth movement of the granular product and also to maintain the device in a hygienic condition. Alternatively, the curved plates 162 define a non-packing surface for bulk materials flow.

A container of the present invention may, in addition to use for the transport and delivery of an aggregate product, may be used as well as for other energy, industrial, or agricultural sector material.

The apparatus 20 allows loading of bulk materials through currently supported mechanisms in the transportation infrastructure (i.e. gravity fed silos and conveyor systems). Its portability allows it to be utilized a variety of application sites and moved using common and convenient methods of arrangement (top-lifting crane, side-entry forklift, and by rear-pulling winch on roll-off truck beds). The intermodal features of the apparatus allow for ease of transport between each of the three modes available in the market today (barge/ship, rail, and truck). By utilizing a single container for material from source to end use, the apparatus allows for protection of product from tampering, weather, corrosion, and degradation through multiple handlings. The apparatus is not limited in its on-site time table as it does not require the costly demurrage of an attached transportation unit (i.e. truck or rail) in order to be utilized. The apparatus can be delivered and stored on site for any desired duration without the need for power or personnel. The apparatus can be configured to connect multiple units together with a manifold via external hoses and have material blown in large volume by pneumatic air pressure under the power of an external blower.

The present invention provides the portable stackable storage and intermodal transportation unit utilizing hopper-shaped design and pneumatic assistance for vacuum pressure aide to the gravity-fed unloading of bulk materials to be hauled via truck, rail, and/or barge for the storage and supply of bulk aggregate materials. The exterior support frame has ISO locks on each corner for attachment and connection for safe transport and integration into current transportation infrastructure and the frame is designed to withstand loading of multiple stacked units. The top of the unit has hatch doors 34 to allow for gravity-fed, top-loading of bulk materials and to protect the bulk materials from damage during storage and transport. An offloading tube or product discharge conduit runs the length of the unit 20 under the hoppers 34. The product discharge conduit attaches to each hopper port by tubing that contains the valve 40 for opening and closing to control the flow of bulk materials into the evacuation tube. The product discharge conduit further may use eductors to allow for air flow from the external blower unit to vacuum pressure the conduit and facilitating the offloading of material. The distal ends of the conduit maybe connected to the blower unit or other discharge mechanism necessary to facilitate the evacuation of the unit. Multiple units may be linked together via hoses to a manifold connected to the blower for greater volume of delivery and supply.

Although particular embodiments of the invention have been illustrated and described, various changes may be made in the form, construction, and arrangement of the parts herein without sacrificing any of its advantages. Therefore, it is to be understood that all matter herein is to be interpreted as illustrative and not in any limiting sense, and it is intended to cover in the appended claims such modifications as come within the true spirit and scope of the invention.

1. A transport and distribution apparatus for bulk granular product, comprising:
a frame;
a container mounted to the frame, the container comprising:
a pair of opposing side walls and a pair of opposing end walls,
a cover attached to the side walls and end walls to close an upper end of the container, the cover defining a plurality of openings each selectively closed by a hatch, for providing entry of a bulk granular product into the container,
an air plenum disposed within the container proximate the cover;
a plurality of chutes attached to the side walls opposing the cover and each having a discharge port;
a product discharge conduit connected at a first end to a supply of pressurized air and a plurality of connector pipes that each connect to a respective one of the discharge ports through a respective valve that selectively positions (1) open for a portion of the bulk granular product to flow from the container through the discharge port into the product discharge conduit or (2) closed for restricting outflow of bulk material product from the container, and
an air supply pipe connected at a first end to the supply of pressurized air and at an opposing end to the air plenum, for communicating pressurized air into the container.

2. The transport and distribution apparatus as recited in claim 1, further comprising a plurality of eductors each disposed in the product discharge conduit downstream of a respective one of the connector pipes.

3. The transport and distribution apparatus as recited in claim 1, further comprising a plurality of drain pipes, each open to an upper surface of the cover and having an outlet open to a side of the container.

4. The transport and distribution apparatus as recited in claim 1, wherein each chute comprises side walls that taper narrowingly from a first end connected to the sidewalls of the container to a second end defining the discharge port thereof.

5. The transport and distribution apparatus as recited in claim 1, wherein each discharge piping member comprises a square circle pipe for connecting at a first end to the hopper and through the discharge port at a second end to the connector pipe.

6. The transport and distribution apparatus as recited in claim 1, further comprising at least one blind bolt attached to the chute, to define a removable plug to close an opening defined in the wall of the chute and selectively removed for receiving therein an aerator that connected to the supply of pressurized air, communicates pressurized air into the chute.

7. The transport and distribution apparatus as recited in claim 1, further comprising at least shaker apparatus attached to the chute for selectively shacking during discharge flow of the bulk granular product from the container.

8. The transport and distribution apparatus as recited in claim 1, further comprising at least one aerator that attaches to the supply of pressurized air and aerator attached to an opening in the chute for communicating pressurized air therein.

9. The transport and distribution apparatus as recited in claim 1, wherein the frame further comprises at opposing upper and lower corners an ISO connector, for securing the frame to a transport vehicle, to an adjacent transport and distribution apparatus, or to a support.

10. The transport and distribution apparatus as recited in claim 1, wherein the cover further comprises a plurality of pipe members, each extending from the cover in axial alignment with a respective one of the openings; and the hatch pivotably attached to the cover, and further comprising a latch for securing the hatch closed over the pipe member.

11. The transport and distribution apparatus as recited in claim 10, further comprising a gasket disposed between the pipe member and the hatch for sealing the opening when the hatch is closed over the pipe member.

12. The transport and distribution apparatus as recited in claim 1, further comprising a magnetic shaker detachably attached to a respective one of the transition members for shaking to assist discharge flow of the product from the container.

13. The transport and distribution apparatus as recited in claim 1, further comprising a plurality of elongated laterally bowed plates, each attached in overlying relation to a corner defined by adjacent side wall and end wall to define a continuous corner surface.

14. A method of distributing bulk granular product from a container, comprising the steps of:
(a) providing a bulk granular product to a container held within a frame of a transportation apparatus, the container comprising:
a pair of opposing side walls and a pair of opposing end walls,
a cover attached to the side walls and end walls to close an upper end of the container, the cover defining a plurality of openings each selectively closed by a hatch plate, for providing entry of a bulk granular product into the container,
an air plenum open to the container;
a plurality of chute assemblies attached to the side walls opposing the cover and having a discharge port; and
a plurality of valves, each connected with a connector pipe to a respective one of the discharge ports and to a product discharge conduit;
(b) selectively moving the plurality of valves from a closed position to prevent outflow of the bulk granular product to an open position to permit flow of the bulk granular product from the container,
(c) providing pressurized air to the product discharge conduit upstream of a first one of the plurality of valves; and
(d) providing pressurized air into the container through an air supply pipe connected to the plenum.

15. (canceled)
